(19) United States
(12) Patent Application Publication
(10) Pub. No.: US 2025/0362691 A1
(43) Pub. Date: Nov. 27, 2025

(54) DRONE SAW

(71) Applicants: Kevin Good, Tequesta, FL (US); Daniel J. Good, Tequesta, FL (US)

(72) Inventors: Kevin Good, Tequesta, FL (US); Daniel J. Good, Tequesta, FL (US)

(21) Appl. No.: 19/293,712

(22) Filed: Aug. 7, 2025

Related U.S. Application Data
(63) Continuation-in-part of application No. 18/540,477, filed on Dec. 14, 2023, now Pat. No. 12,405,618.
(60) Provisional application No. 63/387,980, filed on Dec. 19, 2022.

(51) Int. Cl. G05D 1/689; A01G 3/08; B64U 10/16; B64U 50/34; B64U 101/40; G05D 1/222; G05D 105/15; G05D 109/25

(52) U.S. Cl. CPC G05D 1/6895; A01G 3/086; B64U 50/34; G05D 1/222; B64U 10/16; B64U 2101/40; B64U 2201/20; G05D 2105/15; G05D 2109/254

(57) ABSTRACT

An attachment for an unmanned aerial vehicle (UAV) for trimming tree branches. An articulating arm is mounted to the UAV with a battery powered chain saw positioned along the end of a second articulating arm. The chainsaw allows for the trimming of remote trees and bushes previously only accessible by a ladder or bucket lift. The payload is adjustable forward/aft to maintain the drones center of gravity. The drone includes a remote control receiver, and an antenna allowing an operator to control all aspects of the drone from a remote position.

### PRIORITY CLAIM

In accordance with 37 C.F.R. 1.76, a claim of priority is included in an Application Data Sheet 1 filed concurrently herewith. Accordingly, the present invention is a continuation-in-part (CIP) of U.S. patent application Ser. No. 18/540,477 entitled “DRONE SAWS” having a filing date of Dec. 14, 2023 which further claims priority to U.S. Provisional Patent Application No. 63/387,980, entitled “DRONE SAW”, filed Dec. 19, 2022. The contents of the above referenced applications are incorporated herein by reference in its entirety.

### FIELD OF THE INVENTION

This invention is directed to the field of drones and in particular to a remotely controlled unmanned aerial vehicle that is capable of cutting or trimming trees using a chainsaw that is attached to the vehicle, UAV.

### BACKGROUND OF THE INVENTION

Trimming tree branches is a dangerous occupation. Even with the latest technologies directed to safety guards, the potential of injury is undeniable. Since trees in need of trimming are always tall in stature, individuals assigned to the task must use extension poles and/or ladders to reach areas in need of trimming. For larger limbs, a chainsaw is typically used. Climbing a ladder alone can be dangerous and when used in combination with a chainsaw the individual will likely be working without holding on to the ladder. Falling off a ladder is a known risk and if an individual is standing on a ladder while operating a chainsaw, such a fall can be catastrophic. Placing a chainsaw on an extension pole and operating the combination from a ladder further complicates an already dangerous working condition. The weight of the chainsaw at the end of a pole can be difficult to control due to an extended cantilever effect. In addition, if the tree is near power lines should the operator of the pole mounted chainsaw contact the power lines he may be electrocuted.

Drones or UAV's, the term used interchangeably in this disclosure, are presently being used with photography, inspections, and visual surveillance. From law-enforcement, to search and rescue, the full potential has not even begun to be utilized.

These are a few of the expanding applications of drones currently being used. For instance, U.S. Pat. No. 9,915,946 is directed to rooftop inspections with a drone. U.S. Pat. No. 9,969,495 is directed to drones and package delivery system. U.S. Pat. No. 9,852,644 is directed to drones capable of crop dusting. U.S. Pat. No. 9,829,266 is directed to a gun mounted on a drone recoil system. U.S. Pat. No. 9,764,839 is directed to a drone that can carry a tire water hose to fight fires.

U.S. Pat. No. 7,546,187 discloses a method for navigating a drone having an on-board digital camera. U.S. Pat. No. 7,460,148 discloses a near real time video system for dissemination of video data from surveillance systems. U.S. Pat. No. 7,130,741 discloses a remote control with a user's selection of a GUI map pixel that represents a waypoint for UAV navigation. U.S. Pat. No. 8,869,671 discloses a spring-driven linkage for deploying one or more kicker feet.

U.S. Pat. No. 9,957,045 discloses a stackable drone for carrying a larger payload. U.S. Pat. No. 9,314,922 discloses a remotely operated manipulator. U.S. Pat. No. 9,908,618 discloses an adjustable weight distribution for a drone. U.S. Pat. No. 10,035,596 discloses a drone with a micro engine configured to generate DC power.

U.S. Pat. Nos. 9,844,892 and 9,855,671 disclose a battery operated chain saw. U.S. Pat. No. 9,357,712 discloses a pole attached power tool. U.S. Pat. No. 5,884,403 discloses a powered tree limb trimming device.

What is needed is an improved device and method for trimming tree branches. The device would keep the operator safe from a loss of balance and provide remote access to difficult locations. Ideally the operator can stand a distance from the trimming operation where the operator would be clear of falling debris. Since the operator would be firmly on the ground, or a fixed base location, harmful injuries will be less likely to happen.

### SUMMARY OF THE INVENTION

Disclosed is an improved device and method for trimming tree branches. The device is an attachment to a drone, namely a chainsaw on an articulating arm, along with a battery support rail and batteries, connected to a self leveling hub, suspended by a rotational pivoting swivel coupling, secured to a mount plate that is attached to any drone frame. This swivel coupling keeps the payload's center of mass, dead center. It lets a drone yaw, pitch, and roll freely around that point, while operational, acting as a mechanical gimbal for steady balanced flight. Drones having multiple motors/propellers in either Quad, Octo, or Hexa copter, including a protective cage, can be used with this device.

A self-leveling hub provides a common junction location for the saw, arm, battery, and rails that are suspended from the drone. Acting as a mechanical gimbal, the hub allows the drone to freely gimbal around a balanced payload or saw assembly that it is carrying. There are flight characteristics common to drones wherein the propeller pitch does not change, but the motor speed increases or decreases proportionally to the direction desired. Any direction desired to go then creates a pitch down, and pitch up condition simultaneously. Problems associated with these models of drones are the possible disruptions caused by extra weight, wind condition, operator error or perhaps sudden change of direction. Any of these factors could cause the motors to overcompensate or over adjust creating drone instability. The self-leveling hub compensates for this.

Batteries used in operation can be moved to operate as a counter balancing weight if needed. While the drone and chainsaw are electric the drone could also be powered by a hybrid gas/generator combination for longer flight.

In the preferred embodiment, the drone employed is an octocopter with a protective screen. The drone has a battery power pack with an adjustable forward/aft to compensate the center of gravity. An articulating arm is mounted to the self centering hub with a battery powered chainsaw positioned along the end of the articulating arm. The drone includes a remote control receiver, flight controller and an antenna allowing an operator to control all aspects of the drone from a remote position. This allows the operator to position himself/herself at a location where the top of the tree can be viewed at an acceptable angle. In addition, should the operation be near critical elements, such as beehive, large bird nest, or power lines the remote positioning of the operator in respect to the cutting area provides unprecedented safety.

The drone and saw combination in operation will keep the operator safe from a loss of balance and provide remote access to difficult locations. Ideally the operator can stand a distance from the trimming operation where the operator would be clear of falling debris. Since the operator would be firmly on the ground, or a fixed base location, harmful injuries will be less likely to happen.

An objective of the instant invention is to provide a landscaping drone capable of safely trimming tree branches.

Another objective of the invention is to provide a self-leveling hub for support devices from a drone using a unique rotational pivoting swivel coupling that acts as a mechanical gimbal.

Still another objective of the invention is to provide a landscaping drone that can trim branches close to power lines without subjecting the individual workers to possible electrocution.

Yet another objective of the invention is to provide a landscaping drone that allows trimming of trees and bushes without the need for a ladder.

Another objective of the invention is to provide a landscaping drone having a cutting guard that is movable only when in contact with a branch to be trimmed.

Yet still another objective of the invention is to provide a landscaping drone that operates a chainsaw for efficiently removing unwanted branches.

An objective of the invention is to provide a device and method that allows an operator to be able to cut, trim trees and bushes, from simple jobs, disaster relief: where the operator or “cutter” is in close proximity but firmly on the ground or at a fixed base clear from danger.

Other objectives and further advantages and benefits associated with this invention will be apparent to those skilled in the art from the description, examples and claims which follow.

### BRIEF DESCRIPTION OF THE DRAWINGS

FIG. 1 is a side view of the drone saw;

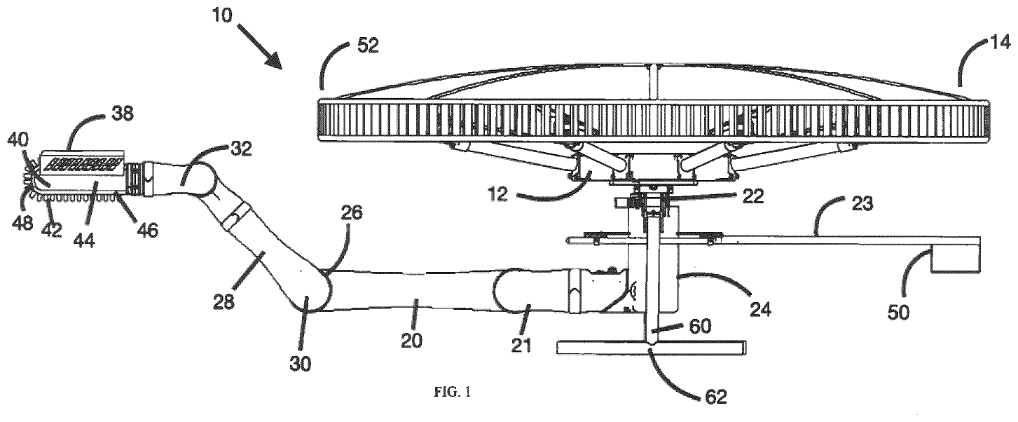

FIG. 2 is a top view thereof;

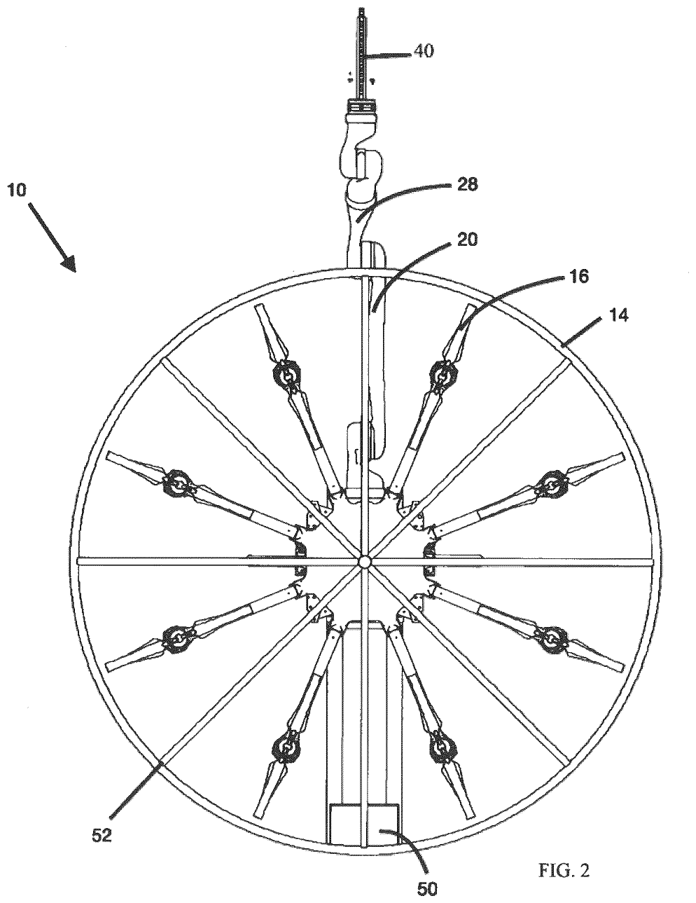

FIG. 3 is a perspective view thereof;

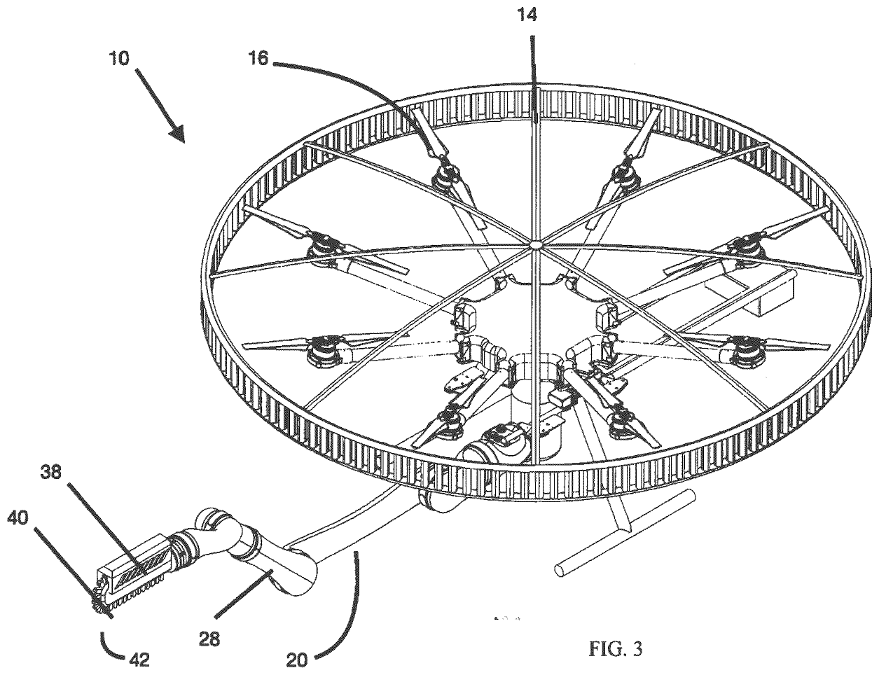

FIG. 4 is an underside perspective view thereof;

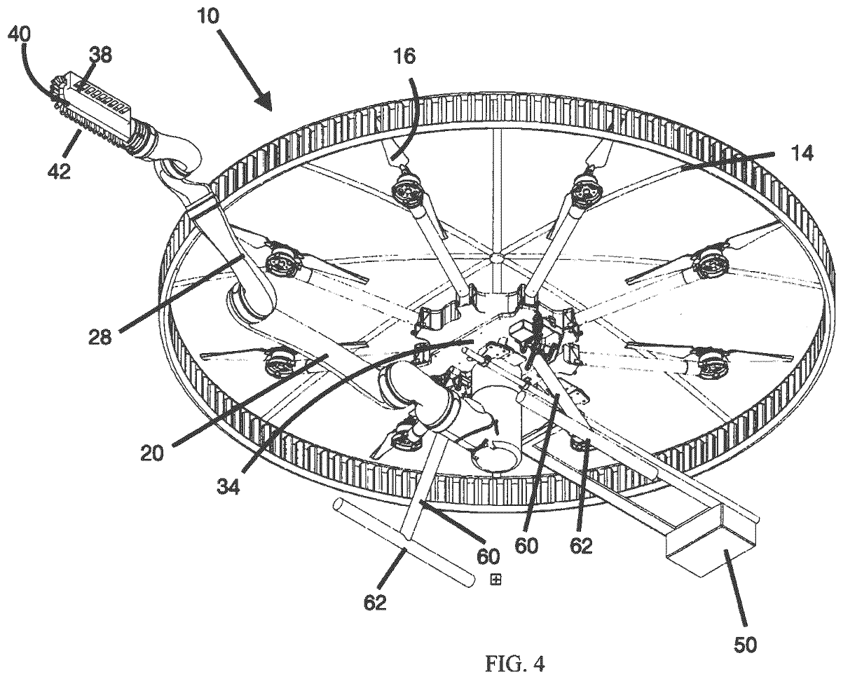

FIG. 5 is a pictorial view of the drone saw;

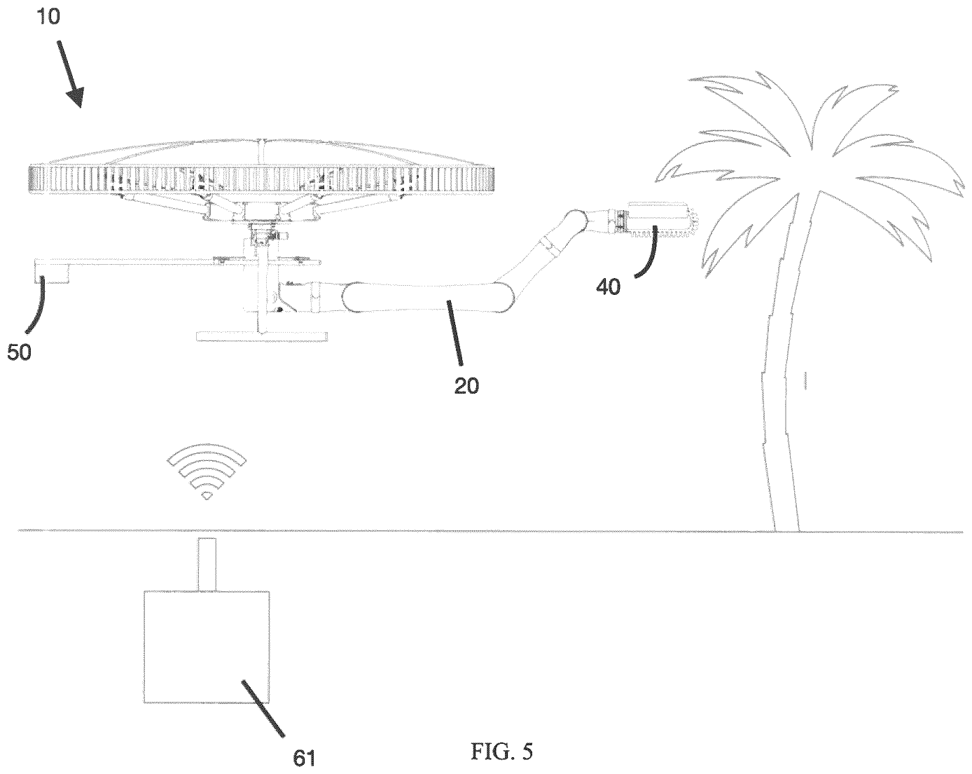

FIG. 6 is a side view of the drone saw depicting the swivel coupling;

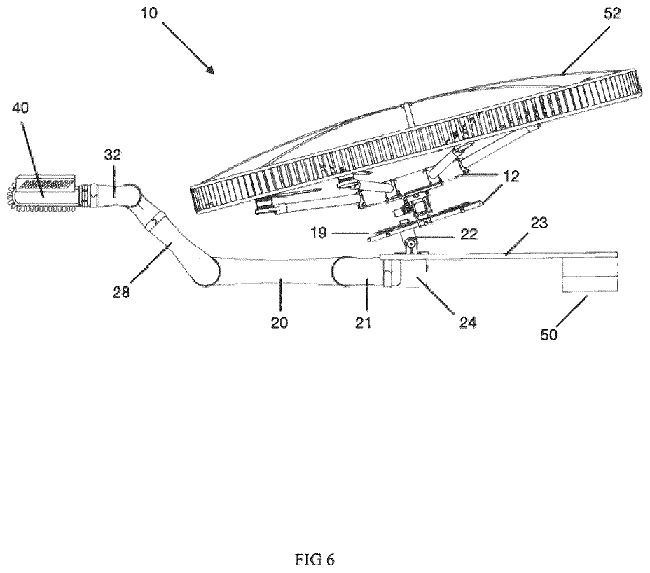

FIG. 7 is a side view of the swivel coupling with the first and second arm; and

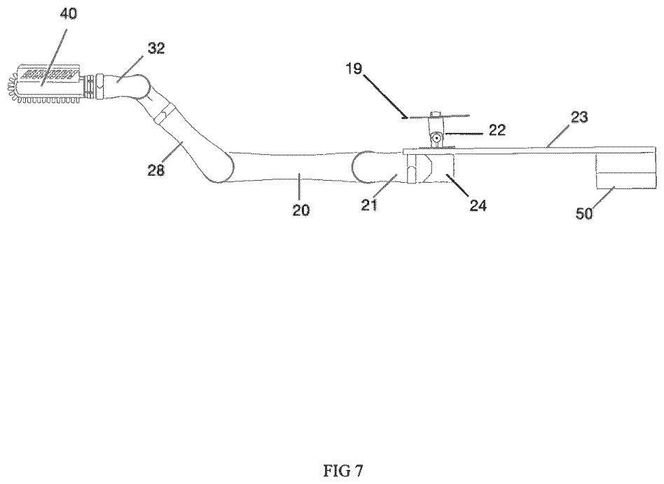

FIG. 8 is an enlarged view of the swivel coupling attached to the mount plate.

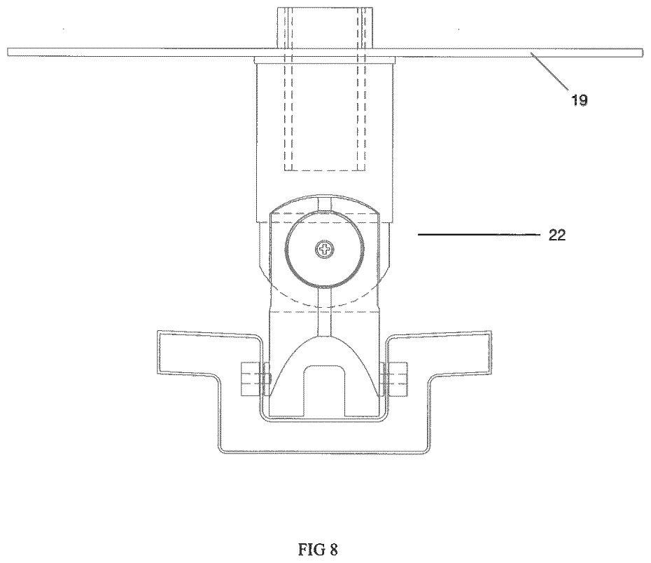

### DETAILED DESCRIPTION OF THE PREFERRED EMBODIMENT

Detailed embodiments of the instant invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

Referring now to the Figures, set forth is a drone saw 10 comprising a base 12 which, in the preferred embodiment, is an octocopter with a protective frame 14. In this embodiment, an octocopter is an unmanned aerial vehicle (UAV) having a propulsion system for generating thrust. The protective frame 14 is positioned so that tree limbs, leaves and the like will not impact the propellers 16 used to enable controlled flight and maintain the drone in flight. In a preferred embodiment, the protective frame 14 provides a protective enclosure for the propellers 16. The drone saw 10 includes a first articulating arm 20 joined to the distal end 21 connected to a self-leveling hub 24 having a pivoting rotational swivel coupling 22 along a proximal end 24 which is secured to a mount plate 19 that is attached to the drone frame 12 with the length of the arm 20 extending to a distal end 26.

Critical to this invention is the use of the self-leveling hub 24 or common junction location for the saw, arm, battery, and rails that are suspended from the drone with a unique rotational pivoting swivel coupling, that acts as a mechanical gimbal. Not so much for the payload saw assembly to gimbal around or about the level drone, but allows for the drone to freely gimbal around the balanced payload or saw assembly that it is carrying.

Since there are flight characteristics with these common drones, whether being a quad, hexa, or octo models, which are considered helicopter type drones. While flying, the propeller pitch doesn't change, but the motor speed increases or decreases proportionally to the direction desired. Any direction desired to go then creates a pitch down, and pitch up condition simultaneously. Some problems associated with these models of drones are; the possible disruptions caused by extra weight, wind condition, operator error or perhaps sudden change of direction. Any of these factors could cause the motors to overcompensate or over adjust creating drone instability.

A second arm 28 is also defined by a proximal end 30 and a distal end 32. The first arm 20 is pivotally coupled to the second arm 28 a fixed distance below a lower surface 34 of the base 12. Movement of the second arm 28 allows for the positioning of the distal end 32 in a location that operator can easily detect.

A saw mechanism 40 is coupled to the distal end 32 of the second arm 28 and, in the preferred embodiment, is comprised of an electrically driven chainsaw formed from a chain saw cutting chain 42 that spins around a chain base 44. The distal end 32 includes an electric motor so as to cause rotation of the chain 42, allowing operation of in the normal and conventional manner. A guard 38 encompasses the chain 42 and is movable along a lower edge 46 of the chain base 44 to allow cutting only along one edge so as to provide protection for operators when the drone is grounded. In this manner, the upper edge 48 of the chain base 44 is shielded which also can be used to prevent engaging limbs on multiple chain base edges. For instance, when the cutting chain 42 is positioned into a heavily foliated tree only one edge of the cutting chain would be engaged.

The drone 10 includes a power source for providing electrical power to the UAV components, which incorporates a battery pack 50. The battery power pack 50 moves along a set of battery support rails 23 joined to the proximal end of the self leveling hub 24 with the rotational pivoting swivel coupling 22 secured to a mount plate 19 attached to the lower frame 12. It is movable between a forward position along the proximal end 24 and an aft position along the outer edge 52 of the frame 12. The battery power pack 50 is adjustable between the forward and aft position so as to provide compensation for the center of gravity when the repositioning of the chainsaw 40 occurs. A leveling mechanism is used for automatically moving the battery pack to maintain a horizontally balanced payload for an even load on the propellers 16 used for lift.

The frame 12 includes retractable landing gear 60 having feet 62 that extend vertically for landing and storage, and fold outwardly against the screen fixed in place allowing the screen 14 to wrap be placed beneath the propeller blades 16 to prevent debris from impacting the bladed 16. For instance, when the drone is operated in heavy foliage, leaves or small tree limbs could impede the operation of the drone should they impact the propeller blades, wherein the screen prevents direct contact.

In an alternative embodiment, the base 12 may be stacked upon a second drone member, not shown, effectively doubling the capacity of the drone 10. The drone 10, as depicted, includes the necessary receiver, antenna, and appropriate flight controller so as to interface with a remote control transmitter 61. The drone 10 includes a control system including a set of processors and actuators configured to receive and process input data and control the flight parameters of the UAV drone 10. In addition, commercial operation of the drone saw requiring longer extended runs is possible by use of a micro engine, such as that disclosed in U.S. Pat. No. 10,035,596, so as to generate power for recharging the battery and operating of the saw. A micro engine is simply a miniaturized internal combustion engine coupled to an appropriate fuel tank.

The drone is preferably made out of lightweight carbon fiber, or a structurally reinforced plastic, so as to minimize weight. The propeller blades 16 are mounted within the frame 12 wherein the screening 14 protects the propeller operation along the upper and lower surfaces of the frame 12. It should be noted that chainsaw operation generates a tremendous amount of small debris, and the preferred operation is for the chain 42 to operate in a direction that prevents jamming while causing the debris to be projected away from the drone frame 12 to help maintain the screens 14 free from debris. The remote control transmitter 61 is designed to operate both the speed of chain rotation, direction, as well as angular articulation of the second arm 28, and rotational position of the first arm 20. In the preferred embodiment, the chainsaw base 44 operates at a position 180° from the battery pack 50 so as to allow ease of battery pack movement to operate as a counterweight. In this embodiment, the first arm 21 can be maintained in a stationary position and the use of a rotational drive to rotate the first arm 20 can be avoided.

All patents and publications mentioned in this specification are indicative of the levels of those skilled in the art to which the invention pertains. It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is adapted to carry out the objectives and obtain the ends and advantages mentioned, as well as those inherent therein. The embodiments, methods, procedures, and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. An attachment for an unmanned aerial vehicle (UAV) for trimming tree branches, comprising:
a self-centering hub coupled to a UAV;
a first articulating arm secured to said self centering hub having a pivoting rotational swivel coupling along a proximal end with the length of said first articulating arm extending to a distal end;
a second articulating arm having a proximal end with the length of said second articulating arm extending to a distal end, wherein said first articulating arm is pivotally coupled to said second articulating arm below a lower surface of said base;
a saw mechanism coupled to said distal end of said second articulating arm having a cutting chain that spins around a chain base;
a control system including a set of processors and actuators configured to receive and process input data and control the flight parameters of the UAV; and
a power source for providing electrical power to the UAV components, said power source including a battery pack, positioned along a set of battery support rails coupled to said self centering hub and movable between a forward position along said self centering hub and an aft position along an outer edge of said frame.

2. The UAV attachment for trimming tree branches according to claim 1 including a micro engine coupled to a fuel tank to generate power for recharging said battery power pack and to operate said saw.

3. The UAV attachment for trimming tree branches according to claim 1, wherein said distal end of said second articulating arm includes an electric motor for rotation of said chain.

4. The UAV attachment for trimming tree branches according to claim 1, wherein said battery power pack is adjustable between the forward and aft position to provide compensation for the center of gravity when the repositioning of said chainsaw occurs.

5. The UAV attachment for trimming tree branches according to claim 1, wherein said control system includes telemetry flight controller to interface with a remote transmitter.

6. The UAV attachment for trimming tree branches according to claim 5, wherein said remote control transmitter operates the speed of the chain rotation, direction, as well as angular articulation of said second articulating arm, and the rotational position of said first articulating arm.

7. The UAV attachment for trimming tree branches according to claim 1, wherein said chain base operates at a position 180° from said battery power pack to allow ease of battery power pack movement to operate as a counterweight.

8. The UAV attachment for trimming tree branches according to claim 1, including a guard encompassing said chain along an upper edge of said chain base, wherein said guard allows cutting only along one edge and provides shielding from engaging limbs on multiple chain base edges.
